(19) United States
(12) Patent Application Publication
(10) Pub. No.: US 2015/0106660 A1
(43) Pub. Date: Apr. 16, 2015

(54) CONTROLLER ACCESS TO HOST MEMORY

(71) Applicant: Lenovo (Singapore) Pte. Ltd., Singapore (SG)

(72) Inventors: Nagananda Chumbalkar, Cary, NC (US); Rod D. Waltermann, Rougemont, NC (US)

(73) Assignee: Lenovo (Singapore) Pte. Ltd., Singapore (SG)

(21) Appl. No.: 14/055,743

(22) Filed: Oct. 16, 2013

(51) Int. Cl. G06F 3/06; G06F 11/07

(52) U.S. Cl. CPC G06F 3/0619; G06F 3/0658; G06F 3/067; G06F 11/0727
USPC 714/42; 711/104; 711/154

(57) ABSTRACT

An apparatus can include a circuit board; a processor mounted to the circuit board; a storage subsystem accessible by the processor; random access memory accessible by the processor; a network interface; and a controller mounted to the circuit board and operatively coupled to the network interface where the controller includes circuitry to capture values stored in the random access memory, the values being associated with a state of the apparatus, and circuitry to transmit the values via the network interface. Various other apparatuses, systems, methods, etc., are also disclosed.

### TECHNICAL FIELD

Subject matter disclosed herein generally relates to technologies and techniques for controllers such as, for example, baseboard management controllers.

### BACKGROUND

An information handling system such as, for example, a server, may include host components that can establish a host operating system environment for executing applications, handling information, etc. As an example, a server may include a controller such as, for example, a baseboard management controller. Various technologies and techniques described herein can provide for controller access to host memory.

### SUMMARY

An apparatus can include a circuit board; a processor mounted to the circuit board; a storage subsystem accessible by the processor; random access memory accessible by the processor; a network interface; and a controller mounted to the circuit board and operatively coupled to the network interface where the controller includes circuitry to capture values stored in the random access memory, the values being associated with a state of the apparatus, and circuitry to transmit the values via the network interface. Various other apparatuses, systems, methods, etc., are also disclosed.

### BRIEF DESCRIPTION OF THE DRAWINGS

Features and advantages of the described implementations can be more readily understood by reference to the following description taken in conjunction with the accompanying drawings.

FIG. 1 is a diagram of an example of a server and an example of a board with various components;

FIG. 2 is a diagram of an example of a system that includes a controller and a processor;

FIG. 3 is a diagram of an example of a system and examples of configurations of system components;

FIG. 4 is a diagram of an example of a method and examples of graphical user interfaces;

FIG. 5 is a diagram of an example of a method and examples of graphical user interfaces;

FIG. 6 is a diagram of an example of a method and examples of graphical user interfaces;

FIG. 7 is a diagram of an example of a method;

FIG. 8 is a diagram of an example of a system and an example of a method;

FIG. 9 is a diagram of an example of a system, an example of a server facility and an example of a method; and

FIG. 10 is a diagram of an example of various components of a machine (e.g., a device, a system, etc.).

### DETAILED DESCRIPTION

The following description includes the best mode presently contemplated for practicing the described implementations. This description is not to be taken in a limiting sense, but rather is made merely for the purpose of describing general principles of the implementations. The scope of the described implementations should be ascertained with reference to the issued claims.

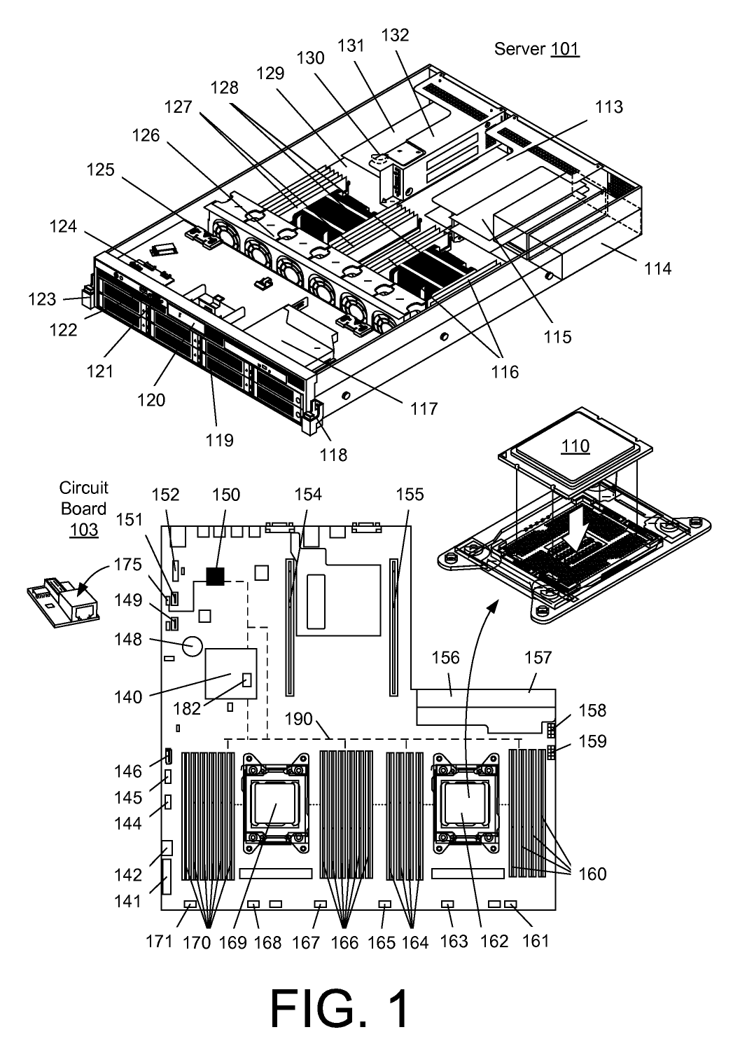

FIG. 1 shows an example of a server 101 and an example of a circuit board 103 that may be part of the server 101. As shown in the example of FIG. 1, the server 101 can include a riser card assembly 113, one or more hot-swap power supplies 114, one or more PCI-express cards 115, a first set of DIMMs 116 (e.g., processor-accessible memory slots, memory modules, etc.), an optical drive 117, a right-side rack handle 118, a hard disk drive area 119, a diagnostic module 120, a VGA DB-connector 121, a USB port 122, a left-side rack handle 123, a front panel board 124, a backplane for hard disk drives 125, system fans 126, a second set of DIMMs 127, heat sinks (e.g., with processors beneath) 128, a circuit board (e.g., or system board) 129, a circuit board battery 130, one or more other PCI-express cards 131 and another riser card assembly 132.

As to the circuit board 103, it may be suitable for use as the circuit board 129 of the server 101. As shown in the example of FIG. 1, the circuit board 103 can include a platform controller hub or host (PCH) 140, a front panel connector 141, an internal USB connector 142, a diagnostic module connector 144, a front VGA connector 145, a SATA connector 146, a circuit board battery 148, an internal USB Type A port 149, a controller 150 (e.g., a baseboard management controller), another internal USB Type A port 151, a TPM (Trusted Platform Module) connector 152 (e.g., to operatively couple to a TPM, another type of security module, etc.), a riser card assembly slot 154, another riser card assembly slot 155, a power supply connector 156, another power supply connector 157, a backplane power connector 158, another backplane power connector 159, memory slots 160, 164, 166 and 170 (e.g., that may be occupied by memory), system fan connectors 161, 163, 165, 167, 168 and 171 and processor sockets 162 and 169 where each of the processor sockets 162 and 169 may seat a respective processor (see, e.g., a perspective view of the processor socket 162 and a processor 110).

As an example, a processor may be in the form of a chip (e.g., a processor chip) that includes one or more processing cores. As an example, a processor socket may include protruding pins to make contact with pads of a processor chip, which may be, for example, a multicore processor chip (e.g., a multicore processor). As an example, a processor socket may include features of a “Socket H2” (Intel Corp, Santa Clara, Calif.), a “Socket H3” (Intel Corp, Santa Clara, Calif.), “Socket R3” (Intel Corp, Santa Clara, Calif.) or other socket. As an example, a processor chip (e.g., processor) may optionally include more than about 10 cores (e.g., “Haswell-EP”, “Haswell-EX”, etc. of Intel Corp.). As an example, a processor chip may include one or more of cache, an embedded GPU, etc.

As shown in the example of FIG. 1, the circuit board 103 may include a controller connector module 175, for example, operatively coupled to the controller 150 (e.g., via conductors, a bus, etc.). The controller connector module 175 may include, for example, network circuitry, a receptacle for a cable plug, etc. for network communications with the controller 150.

As an example, communications (e.g., signal sending, signal receipt, etc.) may occur according to a layer model. For example, such a model may include a Physical Layer (PHY) that can couple to a Media Access Control (MAC) and vice versa. For example, a PHY may be associated with an optical or wire cable and a MAC may be associated with a device (e.g., a link layer device, etc.) that may receive information from the PHY (e.g., received via a cable) and transmit information to the PHY (e.g., for transmission via a cable).

As an example, the controller connector module 175 of the circuit board 103 may provide for remote “keyboard, video and mouse” (KVM) access and control through a LAN and/or the Internet, for example, in conjunction with the controller 150, which may be a baseboard management controller (BMC). As an example, the controller connector module 175 may provide for location-independent remote access to one or more circuits of the circuit board 103, for example, to respond to incidents, to undertake maintenance, etc.

As an example, the controller connector module 175 may include circuitry for features such as an embedded web server, a soft keyboard via KVM, remote KVM, virtual media redirection, a dedicated Network Interface Card (NIC), security (e.g., SSL, SSH, KVM encryption, authentication using LDAP or RADIUS), email alert, etc.

As an example, the controller connector module 175 may be a network adapter (e.g., a network interface). For example, in the example of FIG. 1, the controller connector module 175 is shown as optionally including a receptacle that is configured to receive a plug (e.g., of a cable, etc.). As an example, a utility program may be provided for setting an IP address (e.g., a static IP address or dynamic IP address) for the controller 150. Such a program may include a BMC LAN configuration option and may include options for an identifier and a password. As an example, a controller may be accessed via an IP address (e.g., http://10.223.131.36), for example, using a web-browser program executing on a machine.

As an example, the controller 150 may include one or more MAC modules (e.g., one or more 10/100/1000M bps MAC modules, etc.), for example, that can be operatively coupled to PHY circuitry.

As an example, the controller connector module 175 may include PHY circuitry (e.g., it may be a PHY device or a “PHYceiver”). For example, the controller connector module 175 may include one or more PHY chips, for example, one for each MAC module of a controller where such a controller includes multiple MAC modules. An Ethernet PHY chip may implement hardware send and receive functions for Ethernet frames (e.g., interface to line modulation at one end and binary packet signaling at another end). As an example, a system may include so-called USB PHY circuitry (e.g., a PHY chip integrated with USB controller circuitry to bridge digital and modulated parts of an interface).

As an example, the controller connector module 175 may be integrated with the controller 150, for example, as an integrated management module. As an example, an integrated management module may include at least some features of the Integrated Management Module (IMM) as marketed by Lenovo (US) Inc., Morrisville, N.C. As an example, an integrated management module or the controller 150 and the controller connector module 175 may include circuitry for one or more of: (i) choice of dedicated or shared Ethernet connection; (ii) an IP address for an Intelligent Platform Management Interface (IPMI) and/or a service processor interface; (iii) an embedded Dynamic System Analysis (DSA); (iv) an ability to locally and/or remotely update other entities (e.g., optionally without requiring a server); (v) a restart to initiate an update process; (vi) enable remote configuration with an Advanced Settings Utility (ASU); (vii) capability for applications and tools to access the IMM in-band and/or out-of-band; and (viii) one or more enhanced remote-presence capabilities.

In the example of FIG. 1, the circuit board 103 includes various buses 190 that may provide access to memory such as, for example, memory associated with the slots 160, 164, 166 and 170. As an example, the controller 150 may be operatively coupled to one or more of the various busses 190, for example, to access information stored in memory, to store information in memory or to access information and to store information in memory. As an example, the controller 150 may access memory via the PCH 140, which may include a memory controller host (MCH) and an embedded controller 182 (e.g., an ARC-based controller, an ARM-based controller, etc.), for example, as part of a chipset. As an example, the controller 150 may be configured for direct and/or indirect access to memory such as, for example, so-called “system” memory (e.g., memory associated with the slots 160, 164, 166 and 170).

As an example, the controller 150 may provide for monitoring, debugging, etc. operations of one or more components of the circuit board 103, for example, via access to memory. As an example, the controller 150 may provide for access to states of one or more processors such as, for example, the processor 110, which may include multiple cores and other circuitry. As an example, the controller 150 may optionally set a state of a processor as part of a debugging process, a reset process, etc. As an example, a controller 150 may interrupt operation of circuitry, assess information (e.g., memory, state information, etc.) associated with circuitry and then resume operation of circuitry.

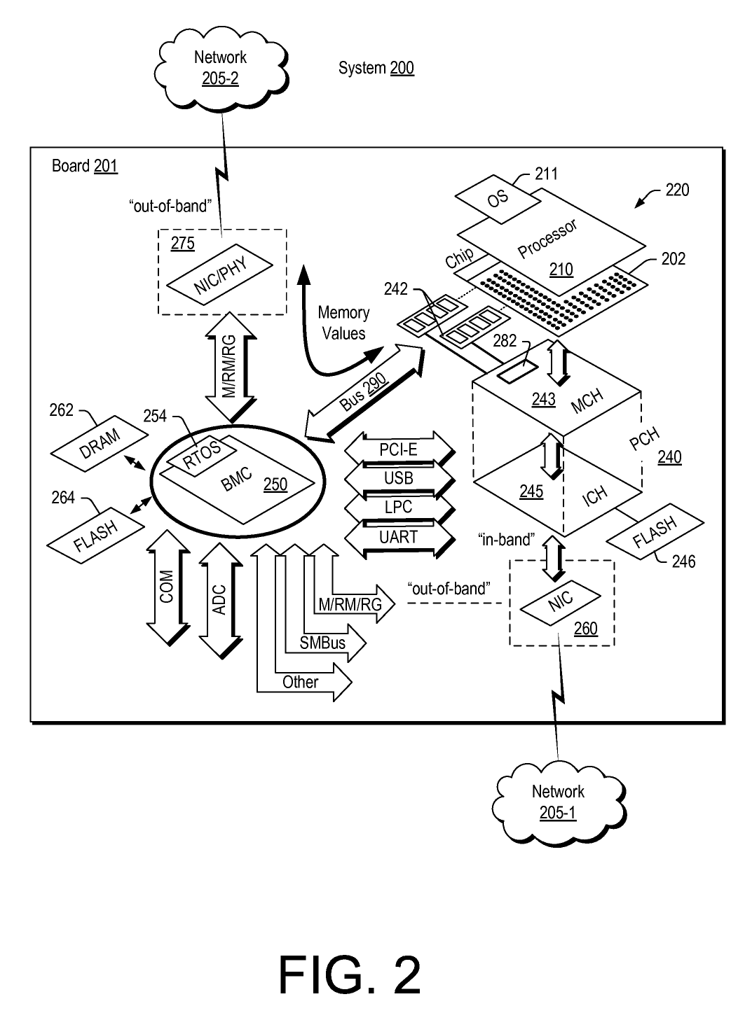

FIG. 2 shows an example of a system 200 that includes a board 201 for a processor chip 202, for a PCH 240 and for a controller 250, which may be referred to as a baseboard management controller (BMC) (see, e.g., the controller 150 of FIG. 1).

As shown in the example of FIG. 2, the processor chip 202 includes a processor 210 that may execute an operating system 211, for example, to establish an operating system environment. In the example of FIG. 2, the processor chip 202 is operatively coupled to a memory controller host (MCH) 243 and an input/output controller host (ICH) 243, which may be, for example, components of the PCH 240. The MCH 243 may be operatively coupled to system memory 242 (see, e.g., the slots 160, 164, 166 and 170 of the circuit board 103 of FIG. 1, which may be occupied with memory) and the ICH 245 may be operatively coupled to a network interface controller (NIC) 260 and include various I/O interfaces. As an example, the ICH 245 may be operatively coupled to flash memory 246 (e.g., SPI flash). As an example, the MCH 243 may include an embedded controller 282. As an example, the chip 202 may provide the processor 210 with access to the memory 242 (see, e.g., where the processor 210 includes appropriate circuitry).

The components illustrated as a vertical stack (right hand side of FIG. 2) may be considered “host” components (e.g., a host 220) that support the establishment of an operating system environment using the processor 210, for example, to execute applications (e.g., using the operating system 211).

In the example of FIG. 2, the controller 250 includes a RTOS 254 and various interfaces. As an example, the controller 250 may include dedicated network support, for example, via circuitry 275 (e.g., a NIC, PHY circuitry, etc.). As an example, the NIC 260 and/or the circuitry 275 may provide for out-of-band (00B) communication with the controller 250 (e.g., via the network 205-1 and/or the network 205-2; see, e.g., the module 175 of FIG. 1). As an example, the controller 250 may include one or more MAC modules (e.g., that may be operatively coupled to one or more PHY devices). As an example, a controller may include an IP address, for example, that may differ from an IP address associated with host components on a board (e.g., the controller 250 may include an associated IP address that differs from an associated IP address of the host 220).

In the example of FIG. 2, the controller 250 may include interfaces to access components such as, for example, DRAM 262, flash 264 (e.g., optionally SPI flash), etc. The controller 250 may include interfaces for communication with one or more of the MCH 243 and the ICH 245, for example, via a PCI-express interface (PCI-E), a USB interface, a low pin count interface (LPC), etc. The controller 250 may include an interface configured in compliance with a SMB specification (e.g., a “SMBus” specification). Such an interface may be configured for communications, control, data acquisition, etc. with one or more components on a motherboard (e.g., power related components, temperature sensors, fan sensors, voltage sensors, mechanical switches, clock chips, etc.).

As an example, the controller 250 may be optionally compliant with an Intelligent Platform Management Interface (IPMI) standard. The IPMI may be described, for example, as a message-based, hardware-level interface specification. In a system, an IPMI subsystem may operate independently of an OS (e.g., host OS), for example, via out-of-band communication.

In the example of FIG. 2, as to the OS 211, an OS environment may be established using, for example, a WINDOW® OS (e.g., a full OS), an APPLE® OS, an ANDROID® OS or other OS capable of establishing an environment for execution of applications (e.g., word processing, drawing, email, etc.). As an example, as to the RTOS 254, the controller 250 may establish an RTOS environment using an RTOS such as, for example, the NUCLEUS® RTOS, a RISC OS, embedded OS, etc.

As an example, the controller 250 may be an ARC-based BMC (e.g., an ARC4 processor with an I-cache, a D-cache, SRAM, ROM, etc.). As an example, a BMC may include an expansion bus, for example, for an external flash PROM, external SRAM, and external SDRAM. A BMC may be part of a management microcontroller system (MMS), which, for example, operates using firmware stored in ROM (e.g., optionally configurable via EEPROM, strapping, etc.).

As an example, the controller 250 may include an ARM architecture, for example, consider a controller with an ARM926 32-bit RISC processor. As an example, a controller with an ARM architecture may optionally include a Jazelle® technology enhanced 32-bit RISC processor with flexible size instruction and data caches, tightly coupled memory (TCM) interfaces and a memory management unit (MMU). In such an example, separate instruction and data AMBA® AHB™ interfaces suitable for Multi-layer AHB based systems may be provided. The Jazelle® DBX (Direct Bytecode eXecution) technology, for example, may provide for execution of bytecode directly in the ARM architecture as a third execution state (and instruction set) alongside an existing mode.

As an example, the controller 250 may be configured to perform tasks associated with one or more sensors (e.g., scanning, monitoring, etc.), for example, as part of an IPMI standard management scheme. As an example, a sensor may be or include a hardware sensor (e.g., for temperature, etc.) and/or a software sensor (e.g., for states, events, etc.). As an example, a controller (e.g., a BMC) may provide for out-of-band management of a computing device (e.g., an information handling system), for example, via a network interface.

As an example, a controller may be configured to implement one or more server-related services. For example, a chipset may include a server management mode (SMM) interface managed by a BMC. In such an example, the BMC may prioritize transfers occurring through the SMM interface. In such an example, the BMC may act as a bridge between server management software (SMS) and IPMI management bus (IPMB) interfaces. Such interface registers (e.g., two 1-byte-wide registers) may provide a mechanism for communications between the BMC and one or more host components.

As an example, a controller (e.g., the controller 250) may store configuration information in protected memory (see, e.g., the DRAM 262, the flash 264, etc.). As an example, the information may include the name(s) of appropriate “whitelist” management servers (e.g., for a company, etc.). As an example, the controller 250 may be operable in part by using instructions stored in memory such as the DRAM 262 and/or the flash 264. As an example, such instructions may provide for implementation of one or more methods that include monitoring, assessing, etc. operation of the processor chip 202 by the controller 250.

As an example, the NIC 260 of the system 200 of FIG. 2 may be a LAN subsystem PCI bus network adapter configured to monitor network traffic, for example, at a so-called Media Independent Interface (MII), a Reduced Media Independent Interface (RMII), a Reduced Gigabit Media Independent Interface (RGMII), etc. As an example, the NIC 260 may include various features, for example, a network adapter may include a Gigabit Ethernet controller, a LAN connector, a CSMA/CD protocol engine, a LAN connect interface between a PCH and a LAN controller, PCI bus power management, ACPI technology support, LAN wake capabilities, ACPI technology support, LAN subsystem software, etc.

As an example, a network adapter (e.g., a NIC, etc.) may be chip-based with compact, low power components with at least PHY circuitry and optionally with MAC circuitry. Such a network adapter may use a PCI-express (PCI-E) architecture, for example for implementation as a LAN on a motherboard (LOM) configuration or, for example, embedded as part of a switch add-on card, a network appliance, etc. (e.g., consider a NIC-based controller for a NIC of a motherboard).

As mentioned, a controller may be provided with access to memory, states, etc. For example, in FIG. 2, a bus 290 is shown, as an example, that operatively couples the memory 242 (e.g., system memory) to the controller 250, which may transmit information stored in the memory 242 to a network (e.g., the network 205-2) via the circuitry 275. As an example, the bus 290 may be a dedicated bus or, for example, it may be a bus such as one of the buses shown as operatively coupling the controller 250 and the host 220. As an example, the controller 250 may be operatively coupled to one or more host components via a SMBus (e.g., a SMLink) (e.g., or other bus).

As an example, the controller 250 may issue an interrupt that acts to interrupt the processor 210 and cause state information for the processor 210 to be stored in a portion of the memory 242, for example, a portion dedicated to storage of processor state information. The controller 250 may access such state information and optionally other information stored in memory, for example, as part of a monitoring process, a debugging process, etc. As an example, the controller 250 may be instructed to issue an interrupt responsive to receipt of a signal received via the circuitry 275 or, for example, according to an algorithm executed by the controller 250, which may be, for example, based on information gathered by the controller 250 (e.g., information as to operational conditions, etc. associated with the board 201).

As an example, the controller 250 may store information to the memory 242, which may include, for example, state information to place the processor 210 in a particular state. For example, as a result of a debugging process or during a debugging process, the controller 250 may place the processor 210 in a particular state and then call for resuming operation of the processor 210, optionally followed by a subsequent interrupt.

As an example, the controller 250 may control one or more timers such as, for example, one or more watchdog timers (WDTs). As an example, a timer may be programmed to call for a reset operation, a power down operation, etc., which may alter information in memory, state of a processor, etc. By controlling one or more timers, the controller 250 may act to preserve information. As an example, by controlling a timer or timers, a controller 250 may proceed with various operations (e.g., debugging operations) with reduced risk of interference from timer associated action(s).

As an example, the controller 250 may be provided with access to information associated with one or more other components of a system. For example, where a component includes a driver, the controller 250 may access information about the driver; where a component includes memory (e.g., cache, etc.), the controller 250 may access that memory; where a component has operational states, the controller 250 may access state information; etc. As an example, the controller 250 may alter a driver, store values to memory, place a device in an operational state, etc., for example, as part of a monitoring process, a debugging process, etc.

As an example, the board 201 may include components such as those marketed by Intel Corporation (Santa Clara, Calif.). As an example, one or more components of the host 220 may support the Intel® Active Management Technology (AMT), as a hardware-based technology for remotely managing and securing computing systems in out-of-band operational modes. In the example of FIG. 2, the Intel® AMT may be implemented using components of the host 220. For example, Intel® AMT may be realized using an ARC4 chip as the embedded controller 282 in the MCH 243 of the host 220 to instantiate the so-called Intel® Management Engine (ME) via code that resides in the same flash memory (e.g., the flash memory 246) as that of host BIOS (e.g., accessible via the ICH 245). The Intel® ME shares a common LAN MAC, hostname, and IP address with the host (e.g., the host OS). The Intel® ME relies on a so-called out-of-band filter to filter information received via a LAN interface (see, e.g., the NIC 260 of FIG. 2).

As an example, a controller may be separate from a host, for example, consider an Aspeed® AST1 XXX or 2XXX series controller marketed by Aspeed Technology Inc. (Hsinchu, TW). As an example, the controller 250 of FIG. 2 may include at least some features of an Aspeed® controller.

As an example, the system 200 may be part of a server. For example, consider a RD630 ThinkServer® system sold by Lenovo (US) Inc. of Morrisville, N.C. Such a system may include, for example, multiple sockets for processors. As an example, a processor may be an Intel® processor (e.g., XEON® E5-2600 series, XEON® E3-1200v3 series (e.g., Haswell architecture), etc.). As an example, a server may include an Intel® chipset, for example, such as one or more of the Intel® C6XX series chipset (see, e.g., the PCH 140 of FIG. 1 and the PCH 240 of FIG. 2). As an example, a server may include RAID hardware (e.g., RAID adapters). As an example, a server may include hypervisor instructions for establishing a hypervisor environment, for example, to support virtual OS environments, etc. As an example, a server may include a controller such as, for example, a controller that includes at least some features of an Aspeed® controller.

As an example, the controller 150 of the circuit board 103 of FIG. 1 or the controller 250 of the board 201 of FIG. 2 may be an Aspeed® controller or include at least some features of such a controller. As an example, the controller connector module 175 of the circuit board of FIG. 1 or the circuitry 275 of the board 201 of FIG. 2 may be configured to operatively couple to an Aspeed® controller or a controller that includes at least some features of such a controller. As an example, circuitry may operatively couple a network interface (e.g., network adapter, PHY circuitry, etc.) to the controller 150 or the controller 250, for example, where the controller connector module 175 or the circuitry 275 includes the network interface (e.g., network adapter, PHY circuitry, etc.).

As an example, the server 101 of FIG. 1 (e.g., or the circuit board 103 of FIG. 1 or the board 201 of FIG. 2) may include a socket for a network interface controller (NIC) that may include, for example, one or more features of an Intel® Ethernet controller, for example, an Intel® 82574 GbE controller, an Intel® 82583V GbE controller, etc.

As an example, the controller 250 of FIG. 2 may optionally include an interface that is operatively coupled to a Test Access Port (TAP) of one or more processors. For example, the chip 202 may include a TAP where a bus (e.g., wires) may provide a link between an interface of the controller 250 and the TAP. In such an example, the controller 250 may transmit and receive information via the TAP, for example, using a TAP architecture. In such an example, the controller 250 may read and capture values (e.g., boundary cell values) associated with a state of the processor 210 and may optionally write values to, for example, boundary cells to place the processor 210 in a desired state.

As an example, a TAP can include a Test Data Input (TDI) connector, a Test Data Output (TDO) connector, a Test Clock (TCK) connector, and a Test-Mode Select (TMS) connector. As an example, a TAP architecture can include a TAP state machine (e.g., TAP logic). In such an example, a controller may selectively use the TAP state machine, for example, to monitor, test, halt, etc. one or more operations associated with a chip that includes the TAP state machine.

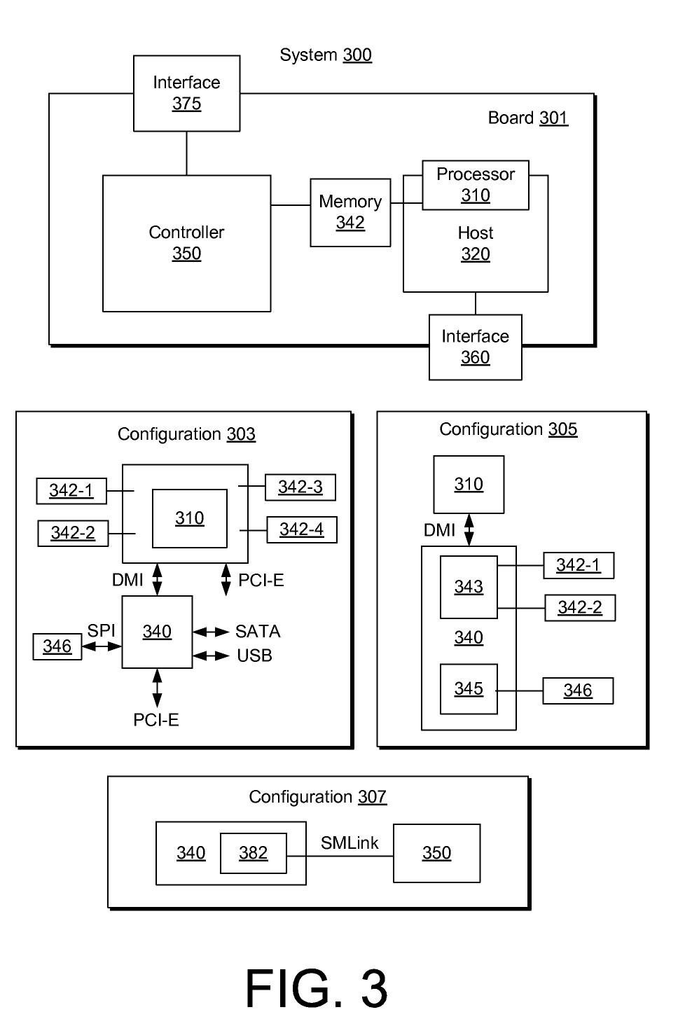

FIG. 3 shows an example of a system 300 that includes a board 301, a processor 310 of a host 320, memory 342 accessible by the processor 310, a controller 350, an interface 360 at least operatively coupled to the host 320, and an interface 375 operatively coupled to the controller 350. In the example system 300, the controller 350 can, directly and/or indirectly, access the memory 342.

FIG. 3 also shows examples of configurations 303, 305 and 307. In the example configuration 303, the processor 310 (e.g., mounted in a socket) may access memory 342-1, 342-2, 342-3 and 342-4 while a PCH 340 may access memory 346. As shown, various interfaces exist, including at least one PCI-E interface associated with the processor 310. As an example, for the configuration 303, the controller 350 may access the memory 342-1, 342-2, 342-3 and 342-4 directly, indirectly or both directly and indirectly.

In the example configuration 305, the PCH 340 includes a MCH 343 and an ICH 345 where the MCH 343 may access the memory 342-1 and 342-2 while the ICH 345 may access the memory 346. The configuration 305 may include various interfaces (e.g., PCI-E, etc.). As an example, for the configuration 305, the controller 350 may access the memory 342-1 and 342-2 directly, indirectly or both directly and indirectly.

In the example configuration 307, the PCH 340 includes an embedded controller 382 that includes a link to the controller 350, which may be a SMLink.

As an example, a PCH may support an advanced TCO mode where a SMLink may be used (e.g., in addition to a host SMBus). For an Intel® chipset, the Intel® ME SMBus controllers can be enabled by soft strap (e.g., TCO Slave Select) in a flash descriptor. A SMLink (SMLink1) may be dedicated to BMC use, for example, such that a BMC may communicate with an Intel® ME through a SMBus connected to SMLink1. For the Intel® C600 series chipset, when the PCH detects a host OS request to go to one of its particular sleep states (S3/4/5), it will take the SMLink1 controller offline as part of the host system preparation to enter the particular sleep state. As an example, a BMC may access information of DIMM thermal sensors via a SMLink.

As an example, the IPMI standard (version 2) describes a system management mode that is an operating mode of a processor responsive to a system management interrupt (SMI). Upon detection of a SMI, a processor will switch into the system management mode, jump to a pre-defined entry vector and save some portion of its state. Per the IPMI standard, a SMI may be generated by software or hardware. Per the IPMI standard, a system may set aside special memory (SMRAM) for execution of instructions and for storage of information such as state information of a processor. As an example, SMRAM may be hidden during normal operation of the processor. As an example, physical memory may be accessible while a processor is in a system management mode (e.g., using memory extension addressing). As an example, I/O interfaces of a processor may be accessible while a processor is in a system management mode.

A SMI may be viewed as freezing execution of a host OS (e.g., freezing an OS environment established by host components). The operational mode of a processor may be viewed as being akin that of ring 0 (e.g., operating system kernel code).

As an example, a controller may be configured to issue an interrupt that halts operation (e.g., causes entry into a particular mode) and optionally to alter one or more timers, to access information associated with an operational state and to resume operation (e.g., leave a system management mode or other mode). In such an example, the actions may be performed with respect to one or more components of a system. As an example, prior to resuming operation, information may be altered, for example, values in memory, state information, etc. For example, a controller may be instructed to alter state information stored in memory (e.g., consider SMRAM, etc.) such that upon issuance of a resume instruction, one or more components are placed in a desired operational state.

As to timers, the IPMI standard (version 2) describes a standardized interface for WDTs. As an example, a timer may be used for BIOS, OS, OEM, etc. applications. As an example, a timer may be configured to generate an action or actions (e.g., upon expiration of the timer). As an example, a timer may cause event logging, for example, to log a timed-out event. As an example, a controller may alter a timer, for example, to avoid timing out, to initiate an immediate time out, etc.

As an example, a controller may include memory for storage of information such as events, sensor data and components. For example, consider a system event log (SEL), a sensor data repository (SDR) and a listing of field replaceable units (FRU). Such memory may be non-volatile memory.

As an example, a controller may perform a monitoring process, a debugging process, etc. where information stored in dedicated non-volatile memory of the controller is accessed and optionally transmitted, for example, optionally in conjunction with information such as state information (e.g., for a processor or other component), component memory information (e.g., system memory information), etc. For example, such transmission of information may occur via a network interface, which may be a dedicated network interface (e.g., dedicated to a controller). As an example, a dedicated network interface may include a dedicated PHY device (e.g., dedicated PHY circuitry).

As an example, a debugging process may include issuing an interrupt, accessing information that may include one or more of SEL, SDR and FRU information and transmitting the information via a network interface. As an example, such a debugging process may further include receiving information via the network interface, storing information to memory and resuming operation of a system based at least in part on the information stored to memory. As an example, the received information may include state information, for example, to place one or more components in a particular operational state prior to resuming operation of the one or more components.

As an example, a debugging process may include calling for local, on-site replacement of one or more field replaceable units. For example, where debugging indicates that a particular component or components are defective (e.g., whether for hardware, firmware or other reason), a notification may be issued to a responsible party for corrective action. In such an example, a controller may be instructed via a network interface to place a system to be serviced in a service-ready state. As an example, a service-ready state may be a power-off state or a particular state that is ready for performing one or more on-site tests, which may allow a worker to further assess one or more components. As an example, a service-ready state may include a notification state, for example, for issuance of a visual indicator and/or audio indicator to facilitate identification of a system, for example, in a facility that includes a plurality of systems (e.g., consider a server in a server farm).

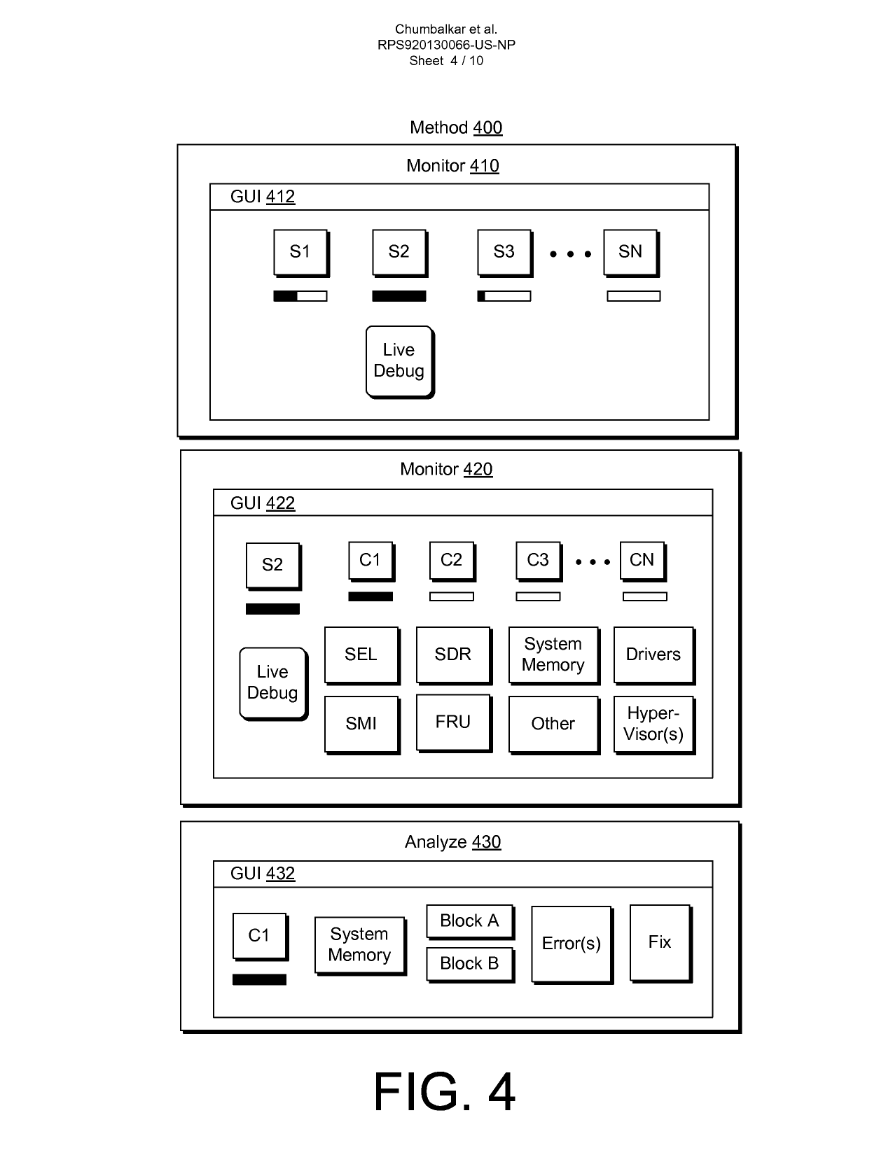

FIG. 4 shows an example of a method 400 and examples of associated graphical user interfaces (GUIs) 412, 422 and 432. As shown, the method 400 includes a monitor block 410 for monitoring one or more servers. For example, the GUI 412 may display a health status indicator as to the health status of one or more servers. As an example, where a health status exceeds a health status limit, a debug control may be presented by the GUI 412. For example, in FIG. 4, the GUI 412 includes a “Live Debug” control that may be activated to commence a debugging process. As an example, a health status that exceeds a health status limit may indicate that a server is in a faulty state (e.g., the health status is due to the server being in a faulty state).

As shown, the method 400 includes a server specific monitor block 420 for monitoring a specific server, for example, a server that may be experiencing a health status issue. As shown, the GUI 422 may display information as to one or more cores of a server, for example, as health status indicators for the one or more cores. In the example of FIG. 4, the GUI 422 also includes various controls for selection of one or more options (e.g., selectable controls provided by execution of instructions, circuitry, etc.). For example, a SEL control may provide for accessing a system event log, a SDR control may provide for accessing a sensor data repository, a FRU control may provide for accessing information associated with one or more field replaceable units, a SMI control may provide for issuing one or more interrupts, a system memory control may provide for accessing system memory, a drivers control may provide for accessing driver information, a hypervisor(s) control may provide for accessing information associated with one or more hypervisors and an other control may provide for one or more other options (e.g., accessing component specific memory, etc.).

As an example, a method may include rendering a GUI to a display and initiating an action responsive to receipt of a selection command for a control of the GUI. For example, a method may include issuing an interrupt that interrupts operation of one or more cores, processors, etc. responsive to receipt of a selection command. In such an example, the interrupt may be communicated to a controller via a network to a network interface of a system where the controller calls for interrupting operation of one or more components of the system. In such an example, the controller may optionally call for altering one or more timers (e.g., WDTs) to allow for debugging or other action (e.g., transferring values from memory, etc.).

As shown, the method 400 includes an analysis block 430 for analyzing information associated with one or more components of a system. For example, the GUI 432 may display a control for accessing system memory information, a control for identifying portions of system memory that may be relevant to a health status issue, a control for analyzing information to identify one or more possible errors (e.g., associated with a health status issue) and a control for implementing a fix to fix a health status issue (e.g., by fixing one or more errors).

As an example, the GUI 432 may provide for accessing state information for a state of a component such as a core or a processor that may include one or more cores. In the example of FIG. 4, in the GUI 432, the “Block A” may be a portion of system memory that includes a captured state of a core or a processor; whereas, the “Block B” may be a portion of system memory that includes values, for example, associated with an OS environment (e.g., whether “virtual” or “real”). As an example, a fix may include writing values to the Block A and/or to the Block B of system memory (e.g., or other memory) to place a system in a particular state, for example, with particular values. As an example, responsive to a resume command (e.g., issued by a controller), a system may resume operation using the values that have been written to memory as an intended fix (e.g., to resolve a health status issue).

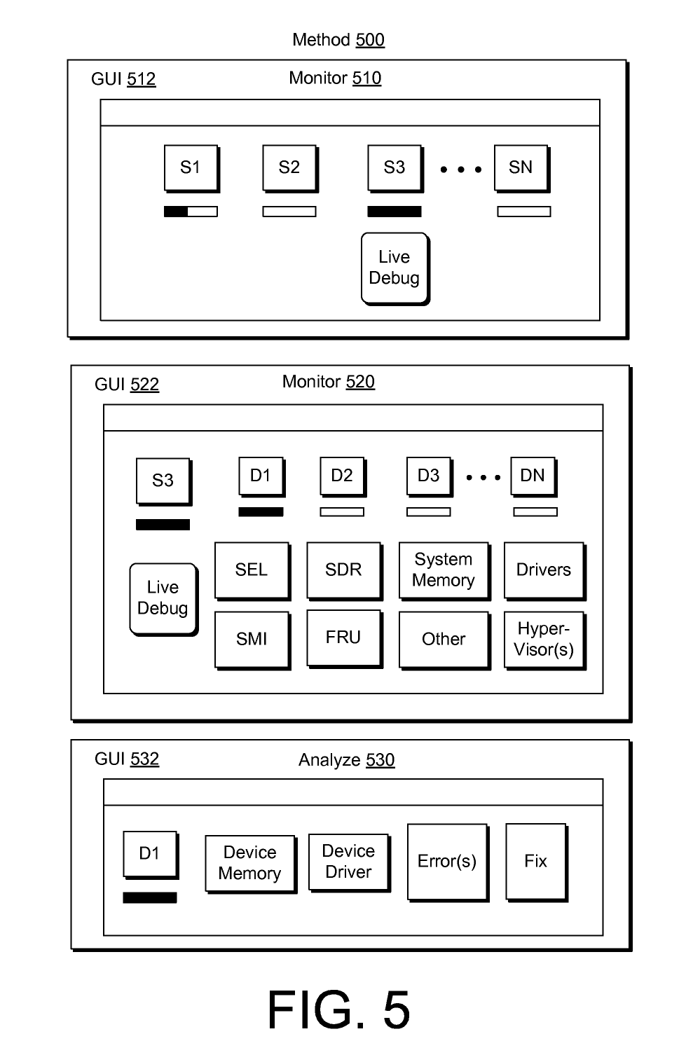

FIG. 5 shows an example of a method 500 and examples of associated graphical user interfaces (GUIs) 512, 522 and 532. As shown, the method 500 includes a monitor block 510 for monitoring one or more servers. For example, the GUI 512 may display a health status indicator as to the health status of one or more servers. As an example, where a health status exceeds a health status limit, a debug control may be presented by the GUI 512. For example, in FIG. 5, the GUI 512 includes a “Live Debug” control that may be activated to commence a debugging process.

As shown, the method 500 includes a server specific monitor block 520 for monitoring a specific server, for example, a server that may be experiencing a health status issue. As shown, the GUI 522 may display information as to one or more devices (e.g., real and/or virtual) of a server, for example, as health status indicators for the one or more devices. In the example of FIG. 5, the GUI 522 also includes various controls for selection of one or more options. For example, a SEL control may provide for accessing a system event log, a SDR control may provide for accessing a sensor data repository, a FRU control may provide for accessing information associated with one or more field replaceable units, a SMI control may provide for issuing one or more interrupts, a system memory control may provide for accessing system memory, a drivers control may provide for accessing driver information, a hypervisor(s) control may provide for accessing information associated with one or more hypervisors and an other control may provide for one or more other options (e.g., accessing component specific memory, etc.).

As an example, a method may include rendering a GUI to a display and initiating an action responsive to receipt of a selection command for a control of the GUI. For example, a method may include issuing an interrupt that interrupts operation of one or more devices, etc. responsive to receipt of a selection command. In such an example, the interrupt may be communicated to a controller via a network to a network interface of a system where the controller calls for interrupting operation of one or more components of the system. In such an example, the controller may optionally call for altering one or more timers (e.g., WDTs) to allow for debugging or other action (e.g., transferring values from memory, etc.).

As shown, the method 500 includes an analysis block 530 for analyzing information associated with one or more components of a system. For example, the GUI 532 may display a control for accessing device memory information, a control for accessing a device driver, a control for analyzing information to identify one or more possible errors (e.g., associated with a health status issue) and a control for implementing a fix to fix a health status issue (e.g., by fixing one or more errors).

As an example, the GUI 532 may provide for accessing state information for a state of a component such as a GPU, a RAID adapter, etc. In the example of FIG. 5, in the GUI 532, the “Device Memory” may be a portion of system memory or other memory (e.g., a device cache, etc.) that may include a captured state associated with a device and the “Device Driver” may be a portion of system memory that includes values, for example, associated with implementation of a device driver in an OS environment (e.g., whether “virtual” or “real”). As an example, a fix may include writing values to the Device Memory and/or to the Device Driver portion of system memory (e.g., or other memory) to place a system in a particular state, for example, with particular values. As an example, responsive to a resume command (e.g., issued by a controller), a system may resume operation using the values that have been written to memory as an intended fix (e.g., to resolve a health status issue).

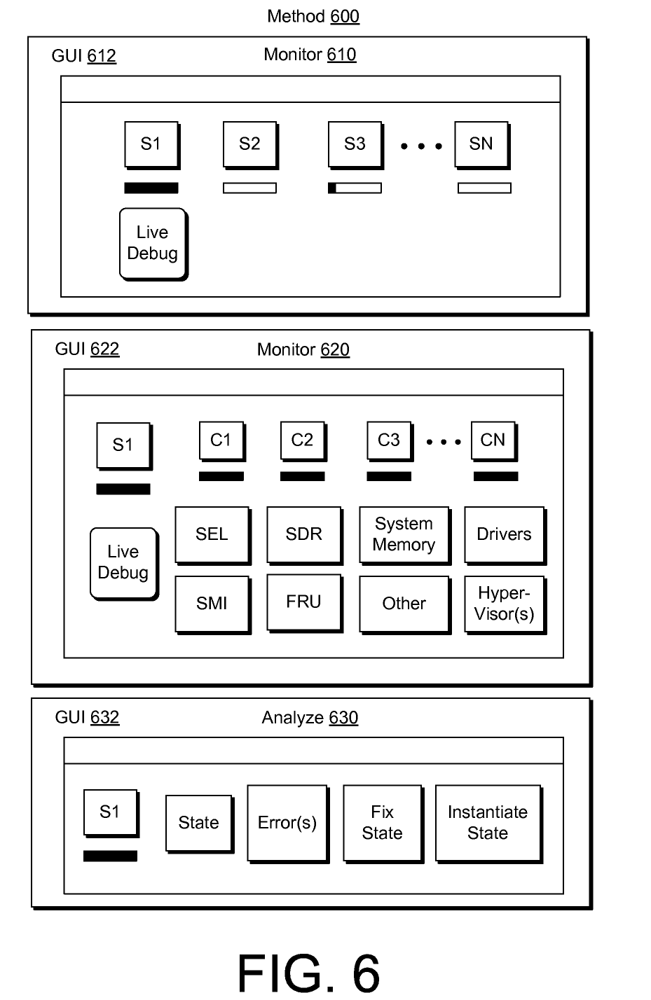

FIG. 6 shows an example of a method 600 and examples of associated graphical user interfaces (GUIs) 612, 622 and 632. As shown, the method 600 includes a monitor block 610 for monitoring one or more servers. For example, the GUI 612 may display a health status indicator as to the health status of one or more servers. As an example, where a health status exceeds a health status limit, a debug control may be presented by the GUI 612. For example, in FIG. 6, the GUI 612 includes a “Live Debug” control that may be activated to commence a debugging process.

As shown, the method 600 includes a server specific monitor block 620 for monitoring a specific server, for example, a server that may be experiencing a health status issue. As shown, the GUI 622 may display information as to one or more cores of a server, for example, as health status indicators for the one or more cores. In the example of FIG. 6, the GUI 622 also includes various controls for selection of one or more options (see, e.g., the GUI 422 of FIG. 4).

In the example of FIG. 6, the GUI 622 indicates that multiple cores of a server are experiencing health status issues. In such an example, receipt of a command for selection of a debug control may include issuing an interrupt via a controller (e.g., a BMC) to place the cores in a particular mode (e.g., a freeze mode) and saving state information for the multiple cores (e.g., whether of a single processor or of multiple processors). As an example, such a method may include altering one or more timers (e.g., WDTs) to allow for freedom in performing one or more debug actions. As an example, a debug action may include an option to alter a timer or timers to cause an immediate time out, for example, to halt operation, to save a state, to preserve values in memory, etc.

As an example, selection of a control of a GUI may include transmitting a command via a network where the command is configured to instruct a BMC, for example, to perform one or more action, which may include a memory access action to access memory associated with one or more processors (e.g., to access system memory). As an example, a command may be part of a packet that includes IP address information, for example, for a MAC module of a BMC. For example, selection of a control of a GUI may initiate construction of a packet that includes address information for a particular controller and one or more instructions (e.g., commands) that instruct the controller (e.g., to access system memory, to transmit values stored in system memory, to place values in system memory, to alter a timer, etc.).

As shown, the method 600 includes an analysis block 630 for analyzing information associated with one or more states of a system. For example, the GUI 632 may display a control for accessing state information, which may be stored in system memory (e.g., SMRAM); a control for analyzing information (e.g., state information, etc.) to identify one or more possible errors (e.g., associated with a health status issue); a control for implementing a fix to fix a health status issue (e.g., by fixing one or more errors), for example, by writing values to memory; and a control for instantiating a state, for example, based at least in part on values written to memory (e.g., system or other memory). As an example, responsive to a resume command (e.g., issued by a controller), a system may resume operation using the values that have been written to memory as an intended fix (e.g., to resolve a health status issue). As an example, instantiation of a state may be part of a debug process, for example, to further analyze a health status issue.

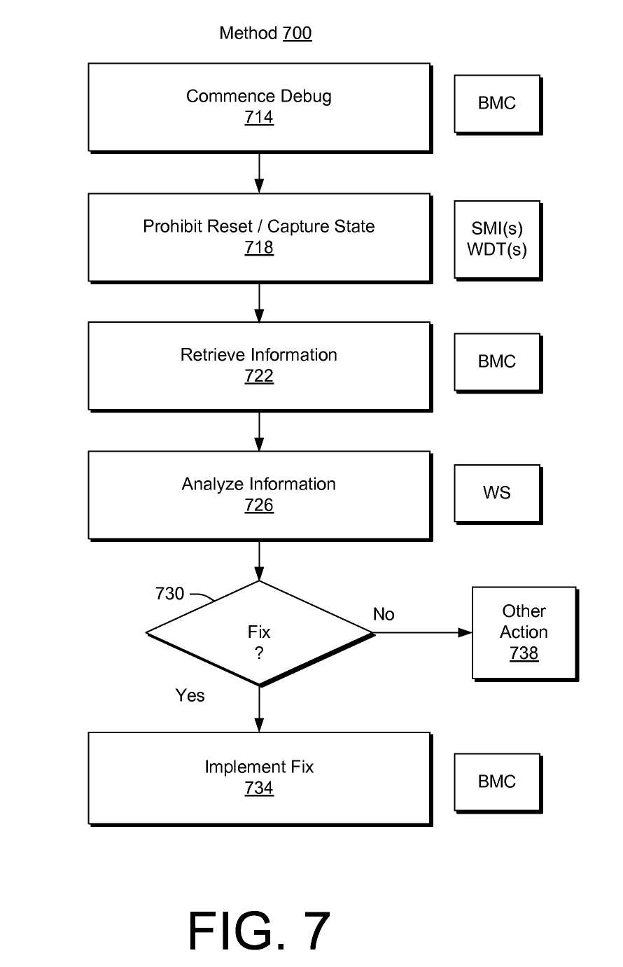

FIG. 7 shows an example of a method 700 that includes a commencement block 714 for commencing a debug process, for example, via a BMC; an action block 718 for taking action that may capture state information and/or prohibit a reset of a component, memory, etc. (e.g., using an interrupt, timers, etc.); a retrieval block 722 for retrieving information (e.g., system memory values, other memory values, state values, SEL values, SDR values, FRU values, etc.); an analysis block 726 for analyzing information (e.g., using a workstation in communication with a system via a network, etc.); a decision block 730 for deciding whether a fix may be available to fix a bug (e.g., or bugs); an implementation block 734 for implementing an available fix (e.g., via a BMC, etc.); and an other action block 738 for taking other action where a fix may not be available. The method 700 of FIG. 7 may optionally be initiated responsive to receipt of an instruction via a network interface, which may be a network interface dedicated to a BMC. As an example, such an instruction may be included in a packet that includes address information for the BMC.

As an example, a method may implement one or more commands associated with a system management mode, which may be, as an example, an IPMI specified system management mode. As an example, a command SMM_{—} CPU_PROTOCOL may provide for access to processor-related information while a processor is in a system management mode. As an example, consider an interface structure: typedef struct _EFI_SMM_CPU_IO_INTERFACE. Such a structure may include a memory parameter (“Mem”) and an I/O parameter (“Io”). As an example, the memory parameter may allow for reads and writes to memory-mapped I/O space and, as an example, the I/O parameter may allow for reads and writes to I/O space. As an example, a service may provide memory, I/O, and PCI interfaces that may be used to abstract accesses to one or more device. As an example, such a service may be configured as a bus driver for purposes of information reads, information writes, debugging, instantiating states, etc. (e.g., consider EFI_SMM_IO_ACCESS, EFI_SMM_PCI_ROOT_BRIDGE_IO_PROTOCOL, etc.)

As an example, a method may implement one or more commands that provide information as to an I/O operation contemporaneous with an interrupt. For example, a command may be an IPMI standard specified command such as: SMM_SAVE_STATE_IO_INFO. Such a command may include parameters for I/O data, I/O port, I/O instruction type, etc.

As an example, a method may implement one or more commands that provide for writing information, which may include state information. For example, a command may be an IPMI standard specified command such as: SMM_CPU_PROTOCOL.WriteSaveState( ) Such a command may write information to a CPU save state. As an example, such an approach may provide for altering a state, for example, as part of a debugging process, a fix, etc. As an example, a SMM_CPU_PROTOCOL.ReadSaveState( ) may provide for reading data from a CPU save state. While various examples mention “CPU” or processor, as an example, one or more commands may be provided and implemented for other devices (e.g., real and/or virtual), device drivers, etc.

As an example, a controller may implement a method that may include entering a system management mode and exiting a system management mode. As an example, a controller may implement a method that includes entering and exiting particular modes multiple times. As an example, a controller may perform a debug process through issuance of commands that may include interrupt commands, read commands, write commands and resume commands.

As an example, a controller may leverage one or more services, which may include one or more IPMI standard specified services (e.g., consider system management mode services). As an example, a controller may operate without reliance on one or more IPMI standard services, for example, where the controller may be configured to issue interrupts, perform reads, perform writes, perform resumes, etc. As an example, where an IPMI standard specified service is impaired (e.g., due to an issue), a controller may optionally perform outside of the IPMI standard specified manner, for example, optionally without relying on IPMI standard infrastructure for the service (e.g., which itself may be impaired).

As an example, system management mode infrastructure may include a processor driver, a MCH driver, a ICH driver and various protocols that may operate using a portion of system memory that may be referred to as SMRAM, for example, for execution of a system management mode engine (e.g., including a handler dispatcher, etc.). As an example, a system management mode engine may establish a protected mode environment for execution of instructions and transfers of information. As an example, a MCH may support a system management mode space. As an example, log APIs (e.g., IPMI standard specified log APIs) may be available in a system management mode, for example, to track, to debug, etc. operations in such a mode.

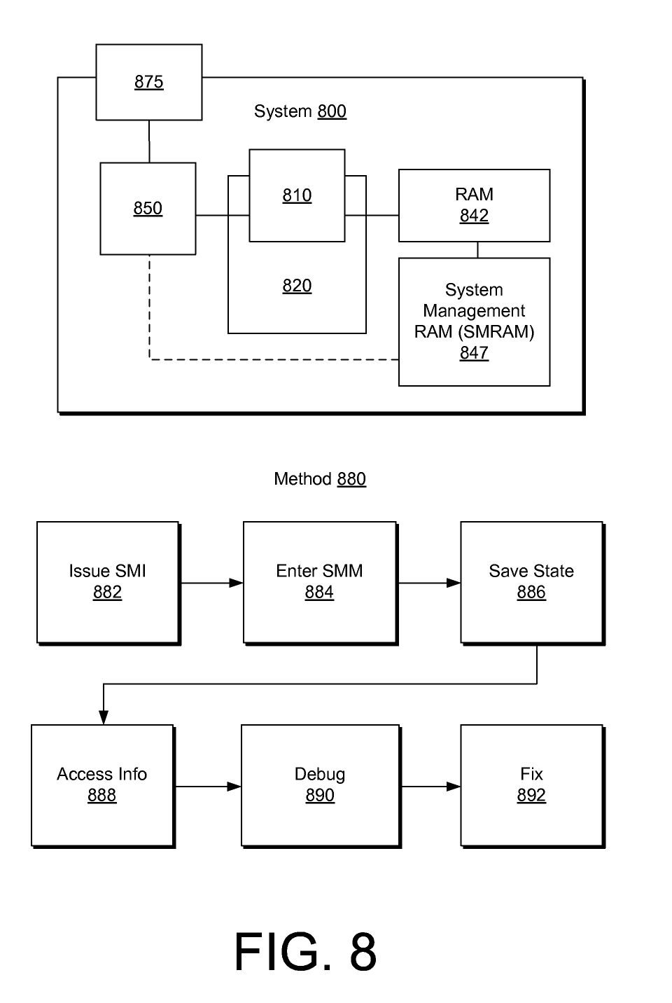

FIG. 8 shows an example of a system 800 and an example of a method 880. As shown, the system 800 includes a processor 810 of a host 820 and memory 842 accessible by the processor 810 and system management memory 847 (e.g., SMRAM), which may be part of the memory 842 and which may be accessible via a controller 850 that is accessible via an interface 875 (e.g., a network interface). In such an example, the controller 850 may access the system management memory 847 outside of a system management mode environment. Thus, while the system management memory 847 may be populated by values responsive to entry into a system management mode, the controller 850 may optionally access such values, as an example, without relying on execution of commands using a system management mode infrastructure.

As an example, the controller 850 may be configured to issue interrupt and resume commands. As an example, the controller 850 may issue an interrupt command, access information stored in memory, analyze the information and/or transmit the information for analysis (e.g., via a network interface) and then issue a resume command (e.g., optionally implementing a fix prior to issuing the resume command).

The method 880 includes an issuance block 882 for issuing a system management interrupt (SMI), an entry block 884 for entering a system management mode (SMM), a save block 886 for saving information associated with operation of a system, an access block 888 for accessing saved information and optionally real-time information (e.g., sensor information, etc.), a debug block 890 for performing one or more debug operations, and a fix block 892 for implementing a fix. As an example, the issuance block 882 may issue an interrupt based on logic of a controller, a communication transmitted to a controller (e.g., via a network interface), a pre-programmed interrupt trigger of a component other than the controller, etc.

As an example, a component such as a RAID adapter may be programmed to issue an interrupt trigger, for example, responsive to an issue detected by the RAID adapter. As an example, a component such as a GPU adapter may be programmed to issue an interrupt trigger, for example, responsive to an issue detected by the GPU. In such examples, a controller may optionally take action responsive to issuance of a device originated interrupt. For example, a controller may transmit a notification via a network interface to a management unit where an operator may further instruct the controller as to subsequent action, for example, in an effort to resolve an issue.

As an example, a management unit may provide for access to one or more databases (e.g., knowledge bases) responsive to a communication from a controller. For example, where a controller reports an event (e.g., as in a SEL) and/or sensor data (e.g., as in a SDR), a management unit may parse the information and perform a search of one or more databases for related information. As an example, information may be related to a FRU where, for example, a FRU vendor database is accessed to search for issue-related information. As an example, where a FRU is deemed faulty, a management unit may issue a notification to a responsible party (e.g., vendor, service provider, etc.) to expedite replacement of the FRU, for example, with server specific information. In such an example, a controller may place the specific server (e.g., or servers) in a particular service-ready state. As an example, a service-ready state may be a secure state, a power state, a combination of states (e.g., a secure, low power state, etc.).

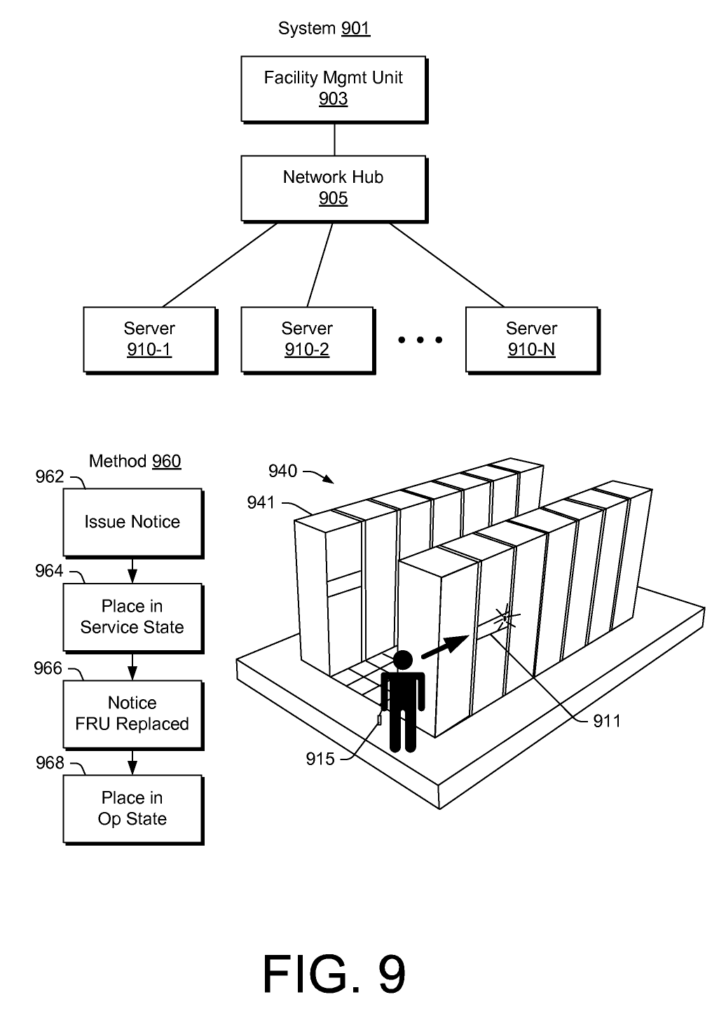

FIG. 9 shows an example of a system 901 that includes a management unit 903, a network hub 905 (e.g., network equipment) and servers 910-1, 910-2, . . . , 910-N. As an example, the management unit 903 may be configured to render GUIs to a display (see, e.g., GUIs of FIGS. 4, 5 and 6). As an example, the management unit 903 may receive information from one of the servers 910-1, 910-2, . . . , 910-N relating to its health (e.g., health status). As an example, where the management unit 903 includes circuitry to analyze such information, one or more commands may be transmitted based in part on an analysis. As an example, if it is determined that replacement of a field replaceable unit (e.g., a component) may fix a health-related issue, the management unit 903 may issue a notification to a responsible party (e.g., a device such as a computing device of the responsible party).

FIG. 9 also shows an example of a system 940 that may include servers such as one or more of the server 910-1, 910-2, . . . , 910-N. Specifically, the system 940 is shown as including racks 941 where each rack can include servers. In the example of FIG. 9, a particular server 911 is identified, for example, to be managed by a worker, for example, where the worker may identify the server 911 because it has been placed into a service-ready state that includes, for example, illuminating a light on the server 911 (e.g., a blinking light, etc., on a front side, a back side, etc.). As shown, the worker may carry a replacement component 915 (e.g., a FRU) or, for example, a storage device that may include instructions for execution by a controller, a host processor, etc. (e.g., to resolve an issue, to debug, etc.).

FIG. 9 also shows a method 960, which includes an issuance block 962 for issuing a notice (e.g., to a responsible party to perform a service), a placement block 964 for placing a server into a service-ready state, a notification block 966 for receiving a notice that a component of the server has been replaced (e.g., the server has been serviced), and a placement block 968 for placing the server into an operational state. Such a method may be implemented by a management unit such as the management unit 903, which may be an informational handling device. Such a method may include transmitting information to and receiving information from a controller of a server (e.g., via a network interface of the server). As an example, the blocks 965 and 968 may include issuing instructions for receipt by a controller to place a server in a state. As an example, the block 966 may include receiving by a management unit a notification issued by a controller of a server that a component has been replaced, that a server has been serviced, etc. As an example, a responsible party (e.g., a worker, etc.) may optionally issue such a notice (e.g., using an information handling device).

As an example, the system 901 and/or the method 960 of FIG. 9 may help to reduce downtime of a server in a facility. As an example, a method may include debugging a server in a facility, for example, to avoid downtime that would be associated with removal of the server. As an example, in situ debugging may facilitate issue discovery as an issue may be associated with conditions in a server facility environment.

As an example, a BMC may be used to capture contents for data structures in an OS environment, for example, in an interactive manner (e.g., via one or more selections made via a GUI).

As an example, a BMC web page of a server (e.g., or servers) may include a “Live Debug” button (e.g., control). In such an example, where a server encounters a critical failure, an operator may actuate the button or, for example, a type of platform even trap (PET) alert may be generated to trigger a BMC to begin capturing information. As an example, a BMC may disable one or more hardware watchdog timers (WDTs), for example, which may possibly cause a system reset.

As an example, a controller may be configured to access host memory in an out-of-band manner and copy over contents at physical addresses such that a range will be passed to the controller. As an example, where a suitable controller helper driver is loaded, memory may be tagged by a signature and, for example, include a virtual address to physical address table. Such an approach may include debug support even in the presence of a processor “hang” condition. As an example, a controller helper driver may be configured to provide kernel data structures, driver buffer locations, etc. such that the controller can repeat an action as many times as required to download required data. As mentioned, if desired, a controller may read and write values (e.g., to known physical locations).

As an example, where a data structure includes a linked-list, a controller may be configured to traverse the list and copy over contents (e.g., where the location of a head node may be passed to the controller). As an example, new addresses may be interactively passed to a controller, for example, so it can copy over contents at those memory locations.

As an example, memory capture functionality may be implemented as a hibernation state save (e.g., a particular operation mode), for example, where intervention may occur using tools such as, for example, Win DBG/Kexec, or checked builds to decode a symbol table (e.g., to gain insight to actual memory or application failure issues).

As an example, a remote live debug of a failed system may be implemented using a controller. For example, where a GPU is suspected to have caused a system failure, such a controller may be instructed to copy over the contents of the physical memory that the GPU and its driver might be using. An analysis of such information may be lead to detection of errors and a possible fix.

As an example, a controller may be configured to read host memory in an out-of-band manner, for example, even on a running system to analyze contents of certain known physical memory locations.

As an example, a controller may provide for tracking down HW errors more efficiently, for example, because the controller may operate independent of a processor (e.g., host processor) and because the controller may include a bus structure configured to access various system resources.

As an example, a controller may be configured to download memory, processor registers and state information, for example, such that a technician in a lab may replicate a scenario and analyze the information in a controllable environment. Such an approach may allow for easier trouble shooting of intermittent and, for example, customer site specific issues.

As an example, an apparatus can include a circuit board; a processor mounted to the circuit board; a storage subsystem accessible by the processor; random access memory accessible by the processor; a network interface; and a controller mounted to the circuit board and operatively coupled to the network interface where the controller includes circuitry to capture values stored in the random access memory, the values being associated with a state of the apparatus, and circuitry to transmit the values via the network interface.

As an example, a controller may include circuitry to halt processing of a processor, for example, to place the processor in a particular mode (e.g., a system management mode, etc.). As an example, a controller may include circuitry to halt a reset operation, for example, by altering one or more timers (e.g., consider a WDT or WDTs).

As an example, a controller may include circuitry to instantiate an operational state. In such an example, the controller may write information to memory where the operational state is instantiated based at least in part on the information written to memory. As an example, memory may be RAM, which may be or include SMRAM.

As an example, responsive to a faulty state (e.g., a state associated with a health-related issue), a controller may include circuitry to instantiate an operational state for debugging the faulty state.

As an example, circuitry to capture values may operate responsive to a trigger. For example, a trigger may be a timer associated with hanging of a processor. As an example, a trigger may be an interrupt, for example, an interrupt issued by a controller or another component of an apparatus.

As an example, an apparatus may include a component and memory for the component where a controller of the apparatus include circuitry to capture values stored in the memory where the values are, for example, associated with a state of the component. In such an example, the component may be a RAID component of a storage subsystem of the apparatus, a GPU of an apparatus, etc.

As an example, an apparatus may include a network interface operatively coupled to a controller. In such an example, the controller may include circuitry to transmit, via the network interface, values stored in random access memory of the apparatus (e.g., system memory). As an example, such values may include state information for a component of the apparatus (e.g., a processor or other component). As an example, a network interface may be a dedicated network interface dedicated to a controller. As an example, an apparatus may include a dedicated network interface dedicated to a controller and an additional network interface operatively coupled to a processor (e.g., a host processor).

As an example, random access memory of an apparatus may be host memory for an operating system environment established by processing of operating system instructions by a processor of the apparatus. As an example, host memory may be system memory.

As an example, a controller may include associated memory that stores operating system instructions executable by the controller to establish a real-time operating system environment (e.g., RTOS environment). As an example, a processor may include a Test Access Port (TAP) accessible by the controller.

As an example, an apparatus may include virtualization circuitry for establishing at least one virtual machine. In such an example, a controller of the apparatus may include association circuitry to associate an established virtual machine with values stored in random access memory of the apparatus.

As an example, a controller of an apparatus may be a baseboard management controller.

As an example, a method may include providing an information handling system that includes a processor, memory, a network interface and a controller operatively coupled to the network interface; and receiving an instruction that instructs the controller to transmit values stored in the memory via the network interface, the values being associated with a state of the information handling system. As an example, such a method may include receiving the instruction via an out-of-band communication path.

As an example, an apparatus can include a processor; memory operatively coupled to the processor; a network interface; and instructions stored in the memory and executable by the processor to instruct the apparatus to receive, via the network interface, values, the values being stored values indicative of a faulty state of an information handling system; and transmit, via the network interface, a debug instruction for debugging the faulty state of the information handling system based at least in part on received values, the debug instruction being executable in a real-time operating system environment to specify an operational state for the information handling system.

As an example, a system may include a hypervisor, for example, executable to manage one or more operating systems. With respect to a hypervisor, a hypervisor may be or include features of the XEN® hypervisor (XENSOURCE, LLC, LTD, Palo Alto, Calif.). In a XEN® system, the XEN® hypervisor is typically the lowest and most privileged layer. Above this layer one or more guest operating systems can be supported, which the hypervisor schedules across the one or more physical CPUs. In XEN® terminology, the first “guest” operating system is referred to as “domain 0” (dom0). In a conventional XEN® system, the dom0 OS is booted automatically when the hypervisor boots and given special management privileges and direct access to all physical hardware by default. With respect to operating systems, a WINDOWS® OS, a LINUX® OS, an APPLE® OS, or other OS may be used by a computing platform.

As described herein, various acts, steps, etc., can be implemented as instructions stored in one or more computer-readable storage media. For example, one or more computer-readable storage media can include computer-executable (e.g., processor-executable) instructions to instruct a device. As an example, a computer-readable medium may be a computer-readable medium that is not a carrier wave.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

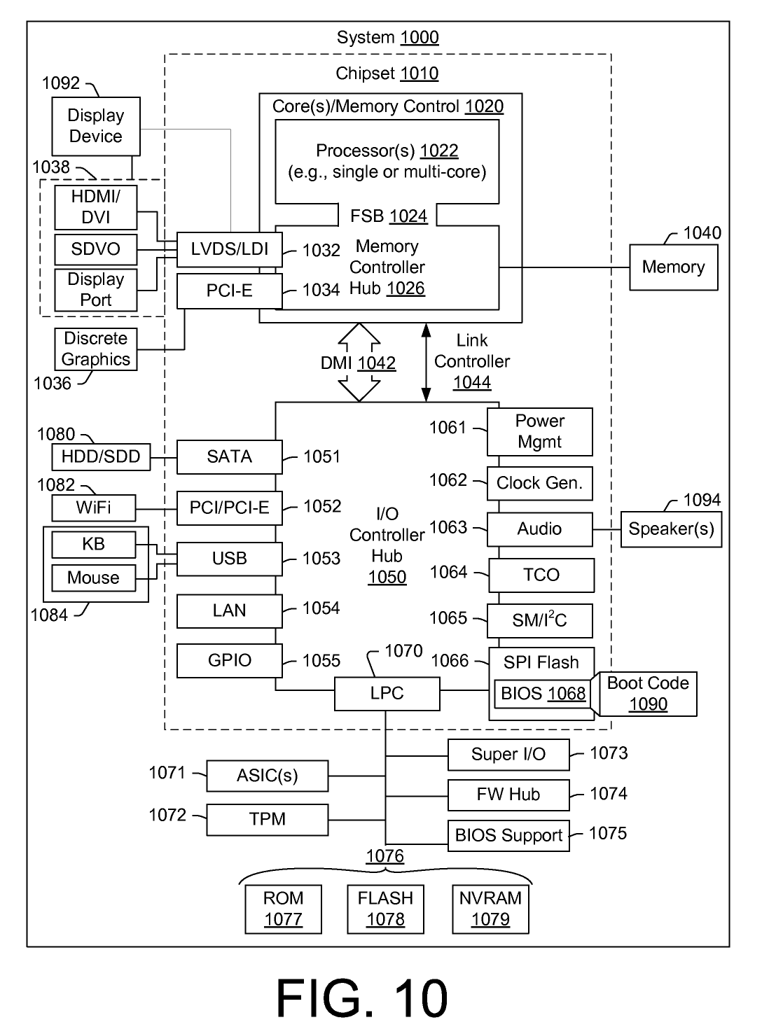

While various examples circuits or circuitry have been discussed, FIG. 10 depicts a block diagram of an illustrative computer system 1000. The system 1000 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a satellite, a base, a server or other machine may include other features or only some of the features of the system 1000.

As shown in FIG. 10, the system 1000 includes a so-called chipset 1010. A chipset refers to a group of integrated circuits, or chips, that are designed to work together. Chipsets are usually marketed as a single product (e.g., consider chipsets marketed under the brands Intel®, AMD®, etc.).

In the example of FIG. 10, the chipset 1010 has a particular architecture, which may vary to some extent depending on brand or manufacturer. The architecture of the chipset 1010 includes a core and memory control group 1020 and an I/O controller hub 1050 that exchange information (e.g., data, signals, commands, etc.) via, for example, a direct management interface or direct media interface (DMI) 1042 or a link controller 1044. In the example of FIG. 10, the DMI 1042 is a chip-to-chip interface (sometimes referred to as being a link between a “northbridge” and a “southbridge”).

The core and memory control group 1020 include one or more processors 1022 (e.g., single core or multi-core) and a memory controller hub 1026 that exchange information via a front side bus (FSB) 1024. As described herein, various components of the core and memory control group 1020 may be integrated onto a single processor die, for example, to make a chip that supplants the conventional “northbridge” style architecture.

The memory controller hub 1026 interfaces with memory 1040. For example, the memory controller hub 1026 may provide support for DDR SDRAM memory (e.g., DDR, DDR2, DDR3, etc.). In general, the memory 1040 is a type of random-access memory (RAM). It is often referred to as “system memory”.

The memory controller hub 1026 further includes a low-voltage differential signaling interface (LVDS) 1032. The LVDS 1032 may be a so-called LVDS Display Interface (LDI) for support of a display device 1092 (e.g., a CRT, a flat panel, a projector, etc.). A block 1038 includes some examples of technologies that may be supported via the LVDS interface 1032 (e.g., serial digital video, HDMI/DVI, display port). The memory controller hub 1026 also includes one or more PCI-express interfaces (PCI-E) 1034, for example, for support of discrete graphics 1036. Discrete graphics using a PCI-E interface has become an alternative approach to an accelerated graphics port (AGP). For example, the memory controller hub 1026 may include a 16-lane (×16) PCI-E port for an external PCI-E-based graphics card. A system may include AGP or PCI-E for support of graphics.

The I/O hub controller 1050 includes a variety of interfaces. The example of FIG. 10 includes a SATA interface 1051, one or more PCI-E interfaces 1052 (optionally one or more legacy PCI interfaces), one or more USB interfaces 1053, a LAN interface 1054 (more generally a network interface), a general purpose I/O interface (GPIO) 1055, a low-pin count (LPC) interface 1070, a power management interface 1061, a clock generator interface 1062, an audio interface 1063 (e.g., for speakers 1094), a total cost of operation (TCO) interface 1064, a system management bus interface (e.g., a multi-master serial computer bus interface) 1065, and a serial peripheral flash memory/controller interface (SPI Flash) 1066, which, in the example of FIG. 10, includes BIOS 1068 and boot code 1090. With respect to network connections, the I/O hub controller 1050 may include integrated gigabit Ethernet controller lines multiplexed with a PCI-E interface port. Other network features may operate independent of a PCI-E interface.

The interfaces of the I/O hub controller 1050 provide for communication with various devices, networks, etc. For example, the SATA interface 1051 provides for reading, writing or reading and writing information on one or more drives 1080 such as HDDs, SDDs or a combination thereof. The I/O hub controller 1050 may also include an advanced host controller interface (AHCI) to support one or more drives 1080. The PCI-E interface 1052 allows for wireless connections 1082 to devices, networks, etc. The USB interface 1053 provides for input devices 1084 such as keyboards (KB), mice and various other devices (e.g., cameras, phones, storage, media players, etc.).

In the example of FIG. 10, the LPC interface 1070 provides for use of one or more ASICs 1071, a trusted platform module (TPM) 1072, a super I/O 1073, a firmware hub 1074, BIOS support 1075 as well as various types of memory 1076 such as ROM 1077, Flash 1078, and non-volatile RAM (NVRAM) 1079. With respect to the TPM 1072, this module may be in the form of a chip that can be used to authenticate software and hardware devices. For example, a TPM may be capable of performing platform authentication and may be used to verify that a system or component seeking access is the expected system or component.

The system 1000, upon power on, may be configured to execute boot code 1090 for the BIOS 1068, as stored within the SPI Flash 1066, and thereafter processes data under the control of one or more operating systems and application software (e.g., stored in system memory 1040).

As an example, the system 1000 may include circuitry for communication via a cellular network, a satellite network or other network. As an example, the system 1000 may include battery management circuitry, for example, smart battery circuitry suitable for managing one or more lithium-ion batteries.

### CONCLUSION

Although various examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. An apparatus comprising:
a circuit board;
a processor mounted to the circuit board;
a storage subsystem accessible by the processor;
random access memory accessible by the processor;
a network interface; and
a controller mounted to the circuit board and operatively coupled to the network interface wherein the controller comprises
circuitry to capture values stored in the random access memory, the values being associated with a state of the apparatus, and
circuitry to transmit the values via the network interface.

2. The apparatus of claim 1 wherein the controller comprises circuitry to halt processing of the processor.

3. The apparatus of claim 1 wherein the controller comprises circuitry to halt a reset operation.

4. The apparatus of claim 1 wherein the controller comprises circuitry to instantiate an operational state.

5. The apparatus of claim 1 wherein the state comprises a faulty state and wherein the controller comprises circuitry to instantiate an operational state for debugging the faulty state.

6. The apparatus of claim 1 wherein the circuitry to capture values operates responsive to a trigger.

7. The apparatus of claim 6 wherein the trigger comprises a timer associated with hanging of the processor.

8. The apparatus of claim 1 comprising a component and memory for the component wherein the controller comprises circuitry to capture values stored in the memory, the values being associated with a state of the component.

9. The apparatus of claim 8 wherein the component comprises a RAID component of the storage subsystem.

10. The apparatus of claim 8 wherein the component comprises a graphics processing unit (GPU).

11. The apparatus of claim 1 wherein the network interface comprises a dedicated network interface dedicated to the controller.

12. The apparatus of claim 11 further comprising an additional network interface operatively coupled to the processor.

13. The apparatus of claim 1 wherein the random access memory comprises host memory for an operating system environment established by processing of operating system instructions by the processor.

14. The apparatus of claim 1 wherein the controller comprises memory that stores operating system instructions executable by the controller to establish a real-time operating system environment.

15. The apparatus of claim 1 wherein the processor comprises a Test Access Port (TAP) accessible by the controller.

16. The apparatus of claim 1 comprising virtualization circuitry for establishing at least one virtual machine and wherein the controller comprises association circuitry to associate an established virtual machine with values stored in the random access memory.

17. The apparatus of claim 1 wherein the controller comprises a baseboard management controller.

18. A method comprising:
providing an information handling system that comprises a processor, memory, a network interface and a controller operatively coupled to the network interface; and
receiving an instruction that instructs the controller to transmit values stored in the memory via the network interface, the values being associated with a state of the information handling system.

19. The method of claim 18 wherein receiving the instruction comprises receiving the instruction via an out-of-band communication path.

20. An apparatus comprising:
a processor;
memory operatively coupled to the processor;
a network interface; and
instructions stored in the memory and executable by the processor to instruct the apparatus to
receive, via the network interface, values, the values being stored values indicative of a faulty state of an information handling system; and
transmit, via the network interface, a debug instruction for debugging the faulty state of the information handling system based at least in part on received values, the debug instruction being executable in a real-time operating system environment to specify an operational state for the information handling system.
